(19) United States
(12) Patent Application Publication
(10) Pub. No.: US 2016/0226325 A1
(43) Pub. Date: Aug. 4, 2016

(54) COOLING DEVICE FOR AN ELECTRIC MACHINE AND ELECTRIC MACHINE COMPRISING A COOLING DEVICE

(71) Applicant: SIEMENS AKTIENGESELLSCHAFT, München (DE)

(72) Inventors: Esteban Grau Sorarrain, Dusseldorf (DE); Christian Jäkel, Duisburg (DE); Mario Koebe, Mulheim an der Ruhr (DE); Matthias Kowalski, Mulheim an der Ruhr (DE); Christoph Lehmann, Neukirchen-Vluyn (DE); Andrey Mashkin, Koln (DE); Olga Plotnikova, Wuppertal (DE); Carolin Schild, Mulheim an der Ruhr (DE)

(73) Assignee: Siemens Aktiengesellschaft, Munich (DE)

(21) Appl. No.: 15/021,600

(22) PCT Filed: Sep. 3, 2014
(86) PCT No.: PCT/EP2014/068680

§ 371 Date: Mar. 11, 2016

(30) Foreign Application Priority Data
Sep. 20, 2013 (EP) 13185286.5

(51) Int. Cl. H02K 1/20

(52) U.S. Cl. CPC H02K 1/20

(57) ABSTRACT

A cooling device for an electric machine includes a stator winding having at least one laminated stator core, which at least one laminated stator core has at least one laminated stator core and at least one stator winding head, wherein the cooling device has a plurality of channels through which a coolant can flow, which channels are connected to a pressure accumulator at a first end and leads into an impingement cooling plate and/or into a channel of a stator winding head at a second end of the channels. An electric machine includes a rotor and a stator, which stator has at least one stator winding, which has at least one laminated stator core and at least one stator winding head; wherein the electric machine includes a cooling device. The electric machine can be a generator and/or a motor.

### CROSS REFERENCE TO RELATED APPLICATIONS

This application is the US National Stage of International Application No. PCT/EP2014/068680 filed Sep. 3, 2014, and claims the benefit thereof. The International application claims the benefit of European Application No. EP13185286 filed Sep. 20, 2013. All of the applications are incorporated by reference herein in their entirety.

### FIELD OF INVENTION

The invention relates to a cooling apparatus for electrical machines, in particular generators, and to an electrical machine having a cooling apparatus according to the invention.

### BACKGROUND OF INVENTION

FIG. 3 shows an electrical machine 101 according to the prior art, more precisely, FIG. 3 shows a cross section through a quadrant of an electrical machine. The structure of the electrical machine 101 is generally rotationally symmetrical about a rotation shaft 5. A rotor 4 is situated on the rotation shaft 5. A stator 2 is arranged concentrically or substantially concentrically around the rotor 4, so that, in the case of a generator, an electrical voltage is induced in the stator 2 in the event of a rotational movement of the rotation shaft 5. Accordingly, when an AC voltage is applied to the stator 2, the rotor 4 can be prompted to rotate about the rotation shaft 5, as is the case with an electric motor, in particular a three-phase motor. The stator 2 typically comprises a stator device winding or stator winding 2a. The stator winding 2a comprises individual laminated cores 2b (also called stator laminated cores or stator device laminated cores) and at least one stator winding head 2c (also called stator device winding head or winding head). Individual laminated cores 2b are typically spaced apart from one another by a distance 2d. During operation of the electrical machine 101, heat is produced on account of losses during the conversion from mechanical to electrical energy (and vice versa), said heat making it necessary to efficiently cool the electrical machine 101. Cooling is necessary since, owing to the used materials for insulating the housing from current and/or voltage-carrying parts, insulation materials which retain their insulation effect only up to a limit value temperature are used. If the limit value temperatures are exceeded, insulation is no longer possible and short circuits and possibly damage to the electrical machine 101 occur. Furthermore, an electrical machine 101 of this kind whose insulation material is no longer effective constitutes a high safety risk since, for example, the housing can be subject to the action of electrical voltages and/or currents, this meaning a risk of accidents. In order to be able to operate the electrical machine 101 at a specific power, sufficient cooling has to be provided, so that the limit value temperatures are not exceeded. Therefore, in order to increase the power of an electrical machine 101 of this kind, it is necessary for effective cooling of active components of the electrical machine 101, in particular of the rotor 4, of the stator 2 and/or of the stator winding head 2c, to be provided. To this end, a fan (not shown in FIG. 3) which is fitted on the rotation shaft and/or a fan which is fitted on the housing for example can be used in order to convey a coolant stream from outside the electrical machine 101 into the interior of the electrical machine and/or in order to circulate said coolant stream in the machine. A geometry of the individual active components rotor 4, stator 2 and/or stator winding head 2c results in a specific ratio in which the coolant mass flow flows to individual active components from amongst said active components and has a corresponding cooling effect. This ratio of the individual mass flows of coolant can generally no longer be changed for the electrical machine 101. As a result, cooling of individual active components is limited. It is known to a person skilled in the art that heat which is collected from the coolant, for example gas and/or cooling liquid in the electrical machine 101, can be drawn away by a corresponding radiator by virtue of a corresponding thermodynamic circulation process and can be fed back to the electrical machine 101, so that continuous cooling of the electrical machine 101 is possible. The object of the invention is therefore to provide a cooling apparatus in such a way that, in particular, the stator 2 can be cooled in a targeted manner. The present invention likewise proposes an electrical machine which comprises a cooling apparatus according to the invention for cooling the stator.

### SUMMARY OF INVENTION

The cooling apparatus for an electrical machine is, in particular, a cooling apparatus for an electrical machine having a stator, wherein the stator comprises at least one stator winding having at least one stator device laminated core and at least one stator device winding head. In the text which follows, the stator is also called a stator device, and accordingly the stator device winding head is also called a stator winding head, and the stator device laminated core is also called a stator laminated core. The corresponding terms are intended to be understood as synonyms in the text which follows.

The cooling apparatus according to the invention comprises a large number of channels through which coolant can flow. The large number of channels is connected to a pressure reservoir at a first end or end section. A second end or a second end section of the large number of channels issues either into a baffle cooling plate and/or ends in a channel of a stator device winding head, wherein the baffle cooling plate advantageously assumes this function. A cooling apparatus of this kind is advantageous since targeted cooling of the stator can be established as a result. A selection of the large number of channels can in particular run between individual stator device laminated cores.

Similarly, as an alternative or in addition, a selection of the large number of channels can run into openings within the stator 2, for example into channels between individual stator laminated cores. The option of choosing which selection of the large number of channels runs into channels between individual stator device laminated cores and/or into openings in the stator, in particular in the stator winding head, allows relative cooling of individual stator device laminated cores in relation to cooling of individual stator device winding heads to be established. In this case, the first selection of the channels which run between individual stator device laminated cores can be equal to the selection which runs into openings in the stator winding head.

Similarly, the selection of the channels which run into the openings in the stator winding head can also be a selection from the large number of channels which run between individual stator device laminated cores.

Similarly, and without restriction, a second selection of the large number of channels can run into channels within the stator. As already mentioned, weighting of cooling of individual stator device laminated cores in relation to individual stator winding heads can be achieved by appropriate selection of the large number of channels.

The cooling apparatus advantageously comprises outlet means. The outlet means can be provided on the baffle cooling plate. As an alternative or in addition, the outlet means can be provided on the at least one channel of the stator device winding head in which at least one selection of the large number of channels ends.

The cooling apparatus advantageously comprises a coolant which flows from the pressure reservoir to the second end of the channels if a lower static pressure prevails at the second end of the channels than in the pressure reservoir. The provision of a lower pressure at the second end of the channels is therefore advantageous since, in this way, a direction in which the coolant flows is defined, so that a flow direction of the coolant can be impressed onto a corresponding cooling circuit.

The outlet means can advantageously be designed such that, in the cooling mode, the static pressure at the second end of the channels is lower than in the pressure reservoir 10a. Corresponding provision of the outlet means is advantageous since the desired flow direction of the coolant in the thermodynamic circulation process is achieved. Furthermore, effective cooling of the stator is achieved with sufficient sizing or dimensioning of the outlet means, for example on the baffle cooling plate.

The baffle cooling plate can advantageously be fitted to an end section of the at least one stator device laminated core. As a result, efficient heat transfer between the baffle cooling plate and the at least one stator device laminated core can be achieved, this leading to effective cooling of the stator device laminated core.

The cooling apparatus can advantageously comprise a second large number of channels through which a coolant can flow and which are connected to a second pressure reservoir in a first end or end section, and end in each case in a second baffle cooling plate and/or in a channel of the stator device winding head at a second end or end section.

The advantage of this embodiment is that both ends of a stator device winding package can be effectively cooled by the first and the second baffle cooling plate. Similarly, stator device winding heads can be effectively cooled by either the second ends of the first channels and/or the second ends of the second channels, which ends each end in a channel or a passage of the stator device winding head.

At least one selection can advantageously run between individual stator device laminated cores and/or a selection of the second channels can preferably run in openings in the stator device laminated core for the second channels too. As an alternative or in addition, a second selection of the second channels can run at least in sections in channels of the stator winding head. An arrangement of the first selection of the second channels and/or of the second selection of the second channels of this kind allows weighting of the relative cooling of the stator device winding package in relation to cooling of the stator device winding heads to be established.

The second baffle cooling plate of the cooling apparatus can further be fitted to a second end section of the stator device laminated core (also called stator laminated core or laminated core). Therefore, the stator device winding package can advantageously be effectively cooled at both ends by means of the first and the second baffle cooling plate, this allowing heat to be transported away more efficiently.

As for the first pressure reservoir, the second pressure reservoir can also contain a coolant which flows from the second pressure reservoir to the second end of the second channels if a lower static pressure prevails at the second end of the second channels than in the second pressure reservoir. An embodiment of this kind is advantageous since a direction of the coolant flow is impressed onto the thermodynamic circulation process for cooling by the cooling apparatus according to the invention, without special drive means, for example in the form of pumps, being required for this purpose.

The cooling apparatus can advantageously comprise second outlet means which are designed such that, in the cooling mode, the static pressure at the second end of the second channels is lower than in the second pressure reservoir, as has already been explained for the first outlet means. Both for the first outlet means and for the second outlet means, the cooling mode can be designed such that measurable cooling of the electrical machine takes place by virtue of the cooling apparatus. This can take place during operation of the electrical machine and/or when the electrical machine is stationary.

In a cooling apparatus according to the invention, first channels and second channels can advantageously alternate in a circumferential direction within the stator 2, this allowing space-saving cooling of the stator. In particular, the stator can advantageously be cooled in a uniform manner owing to the use of the two cooling circuits and/or the alternating arrangement of first channels and/or second channels. Furthermore, the invention relates to an electrical machine. This electrical machine comprises a rotor and a stator, wherein the stator comprises at least one stator device winding having at least one stator device laminated core and at least one stator device winding head. The electrical machine according to the invention further comprises a cooling apparatus, as described above, according to the present invention. The electrical machine according to the invention may advantageously be a generator and/or a motor.

### BRIEF DESCRIPTION OF THE DRAWINGS

The above-described properties, features and advantages of this invention and the manner in which said properties, features and advantages are achieved will become clearer and more explicitly explained in connection with the following description of the exemplary embodiments which are explained in greater detail in connection with the drawings, in which

FIG. 1 shows a detail of the cooling apparatus 1 according to the invention which is fitted to a quadrant of a stator 2,

FIG. 2 shows a second embodiment of the cooling apparatus 1 according to the invention using a detail of a quadrant of a stator 2 of an electrical machine 100, and

FIG. 3 shows a detail of a quadrant of an electrical machine 101 according to the prior art.

### DETAILED DESCRIPTION OF INVENTION

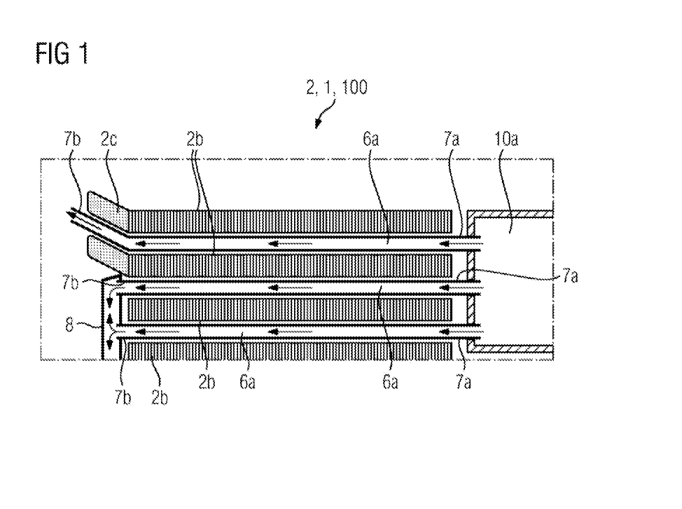

FIG. 1 shows a detail of an electrical machine 100, in particular a detail of a stator 2 which comprises a cooling apparatus 1 according to the present invention in a first embodiment. The stator 2 is composed of a large number of stator device laminated cores 2b (also called laminated cores or stator laminated cores) as illustrated. The individual stator device laminated cores 2b are arranged such that first channels 6a run between said stator device laminated cores. The first channels 6a are connected to a pressure reservoir 10 at first ends or first end sections 7a. At second ends or second end sections 7b, the first channels 6a are either flow-connected to a baffle cooling plate 8 and/or are arranged in a channel of a stator winding head 2c. If a higher static pressure prevails in the pressure container 10 (shown on the right-hand side in FIG. 1) than at the second ends 7b of the first channels 6a, a coolant which is located in the pressure container 10 flows from the pressure container 10 to the second ends 7b of the first channels 6a, as indicated by the arrows. A person skilled in the art knows how to dimension the baffle cooling plate 8 in order to ensure the lower pressure at the second ends 7b of the channels 6a, which second ends end in the baffle cooling plate 8. To this end, suitable outlet means (not shown) can be provided on the baffle cooling plate 8, so that effective cooling, that is to say baffle cooling, can be achieved. Owing to the baffle cooling, the adjacent stator device laminated cores 2b, which are in contact, are cooled by the baffle cooling plate 8. It is of interest to maintain a flow of the coolant in order to effectively dissipate heat from the stator 2. Furthermore, the lower static pressure which is provided at the baffle cooling plate 8 and/or at the second ends 7b of the first channels 6a ensures that the coolant flows in a desired direction within the first channels 6a, as a result of which heat is transported away and therefore the stator device laminated cores 2b are cooled as desired. For second ends 7b of the first channels 6a, which second ends end in the stator device winding head 2c, a sufficiently large outlet has to be provided so that the lower static pressure, that is to say in particular lower than in the pressure reservoir 10, is also maintained at the second end 7b of the first channels 6a which issue into the stator device winding head 2c. Suitable outlet means which ensure that coolant flowing out of the second ends 7b can be discharged in a sufficient quantity in order to ensure the lower static pressure at the second ends 7b of the first channels 6a in the cooling mode are known to a person skilled in the art.

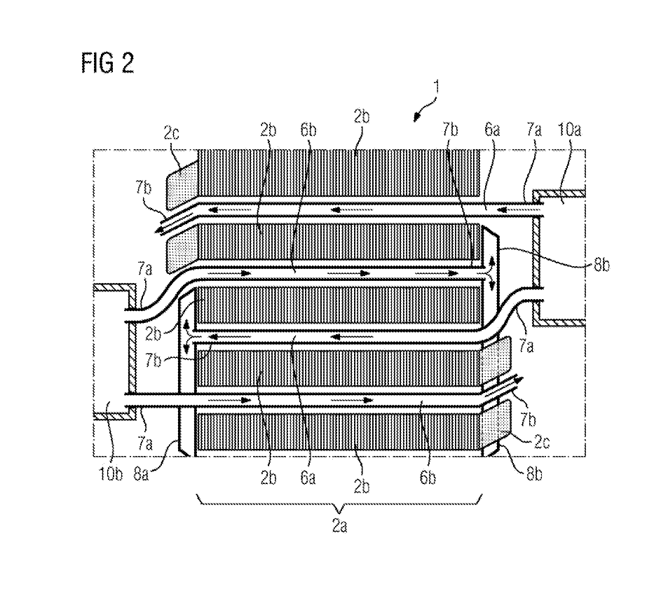

FIG. 2 shows, by way of example, a cooling apparatus 1 according to a further embodiment of the invention, which cooling apparatus is fitted in an electrical machine 100, wherein FIG. 2, as already shown in FIG. 1, shows only a section through a quadrant of the electrical machine 100 to the extent that is necessary for understanding the cooling apparatus 1 according to the invention and/or the electrical machine 100 according to the invention. In addition to the first channels 6a between a first pressure reservoir 10a and a first pressure plate 8a and/or a first stator device winding head 2c, a large number of second channels 6b which start from a second pressure reservoir 10b are provided. First ends 7a of the second channels 6b end in the second pressure reservoir 10b. A second end 7b of the second channels 6b ends in a second baffle cooling plate 8b and/or in a stator device winding head 2c. The arrangement of stator device winding head 2c and/or the first baffle cooling plate 8a and of the second baffle cooling plate 8b is provided only by way of example in FIG. 2 and is intended to explain the principle of the second embodiment of the invention. Owing to the use of the first and the second pressure reservoir 10a, 10b in conjunction with the first and the second baffle cooling plate 8a, 8b, effective cooling of the stator laminated cores 2b can be achieved from both sides, that is to say from both ends of the respective stator device laminated cores 2b between the first and the second baffle cooling plate 8a, 8b. The more effective cooling of the stator laminated cores 2b also results in more effective cooling of the stator. It is of interest to provide a lower static pressure at the respective second end sections 7b of the first channels 6a and/or the respective second end sections 7b of the second channels 6b than in the respectively connected first or second pressure container 10a, 10b in order to impress a desired flow direction onto the coolant in the interior of the first channels 6a and/or in the interior of the second channels 6b and therefore to provide a flow direction of the thermodynamic circulation process, as is used for cooling the stator 2, without further drive means, for example in the form of pumps.

It will be understood by a person skilled in the art that other arrangements with two baffle cooling plates 8a, 8b and two pressure containers 10a, 10b are also possible. One option is to alternate first channels 6a and second channels 6b in a circumferential direction of the stator 2. More than only first and second channels 6a, 6b can also be used without restriction, said first and second channels each being connected to a further pressure container (not shown) and possibly a further baffle cooling plate (not shown).

It will be understood by a person skilled in the art that either a gaseous coolant, for example air, oxygen and/or hydrogen, can be used as a coolant for the embodiments of the invention. Hydrogen would be particularly advantageous on account of the high thermal capacity and therefore the high ability to draw heat from the stator device laminated cores 2b and/or the stator device winding heads 2c. A person skilled in the art knows that safety precautions are necessary when using hydrogen as coolant in order to avoid an oxyhydrogen gas explosion. Safety apparatuses of this kind are known to a person skilled in the art, are not required for understanding the present invention and therefore will not be explained further in connection with the present invention.

It would likewise be possible to use a liquid as the coolant, said liquid flowing in first channels 6a and/or second channels 6b and in further channels. In particular, a non-conductive liquid, for example distilled water, can be considered in this connection. As an alternative and/or in addition, generator oil can also be used. When using electrically conductive coolants which, in particular, flow out of the second ends 7b within the stator device winding heads 2c, it is necessary to ensure that said coolant does not cause a short circuit between electrically conductive components of the stator winding 2a or of the stator 2. It is likewise necessary to prevent a conductive coolant creating a short circuit between the stator 2 and/or the rotor, just like between other electrically conductive components of the electrical machine 100. However, corresponding precautions are known to a person skilled in the art and therefore will not be explained further in connection with the present description.

Although the cooling apparatus 1 according to the invention has been explained in connection with stator laminations 2b (also called stator laminated cores, stator device laminations, stator device laminated cores, or stator devices), it is feasible, without restriction, to provide the cooling apparatus 1 on laminated cores of the rotor 4. However, for cooling according to the invention of the rotor 4, it would be necessary for the pressure containers 10a, 10b to be fitted on the rotation shaft 5 and to rotate when the rotation shaft 5 rotates, this making an arrangement of the cooling apparatus 1 on the rotor 4 more difficult.

It is obvious to a person skilled in the art that the cooling apparatus 1 described in connection with FIGS. 1 and 2 can be combined with further cooling apparatuses of an electrical machine 100, in order to in this way achieve the requisite cooling of the stator 2, of the rotor 4 and/or of the stator device winding heads 2c.

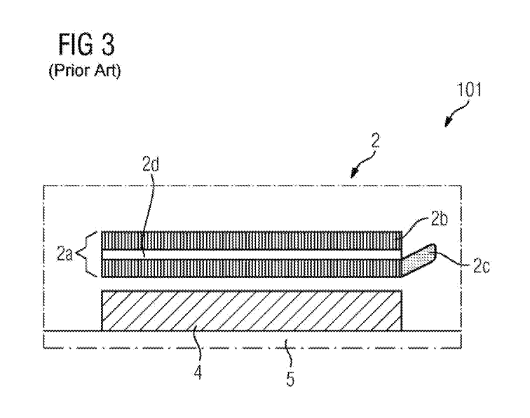

As shown in FIGS. 1 and 2, the present invention also discloses an electrical machine 100 having a rotor 4 (shown in FIG. 3) and a stator 2, wherein the stator comprises at least one stator winding 2a with at least one stator laminated core 2b, as shown in FIGS. 1 and 2, wherein the electrical machine 100 comprises the cooling apparatus 1 according to the invention, as explained in connection with FIGS. 1 and 2.

The electrical machine according to the invention may be, without restriction, a generator and/or a motor.

The present invention is not restricted to the stated exemplary embodiments of the cooling apparatus 1 and/or of the electrical machine 100. Although the invention has been illustrated and described in detail by the exemplary embodiments of the cooling apparatus 1 and embodiments of the electrical machine 100, the invention is not restricted by the examples disclosed in this document. Rather, variations of the embodiments disclosed in this document can be derived by a person skilled in the art, without departing from the scope of protection of the invention.

1. A cooling apparatus for an electrical machine having a stator comprising at least one stator winding, having at least one stator laminated core and at least one stator winding head; the cooling apparatus comprising:
a large number of channels through which a coolant can flow and which are connected to a pressure reservoir at a first end section and end in a baffle cooling plate and/or in a channel of a stator device winding head at their second end section.

2. The cooling apparatus as claimed in claim 1,
wherein at least a selection of the large number of channels runs between individual stator device laminated cores; and/or at least a selection of the large number of channels runs into openings in the stator winding head.

3. The cooling apparatus as claimed in claim 1, further comprising:
an outlet on the baffle cooling plate and/or the at least one channel of the stator device winding head.

4. The cooling apparatus as claimed in claim 1,
wherein a coolant flows from the pressure reservoir to the second end section of the channels if a lower static pressure prevails at the second end section than in the pressure reservoir.

5. The cooling apparatus as claimed in claim 3,
wherein the outlet is designed such that, in the cooling mode, the static pressure at the second end section of the channels is lower than in the pressure reservoir.

6. The cooling apparatus as claimed in claim 1,
wherein the baffle cooling plate can be fitted to an end section of the at least one stator device laminated core.

7. The cooling apparatus as claimed in claim 1, further comprising:
a large number of second channels through which a coolant can flow and which are connected to a second pressure reservoir at a first end and end in a second baffle cooling plate and/or in a channel of the at least one stator device winding head at a second end section.

8. The cooling apparatus as claimed in claim 7,
wherein at least a selection of the second channels runs between individual stator device laminated cores and/or at least a selection of the second channels runs into openings in the stator device laminated core.

9. The cooling apparatus as claimed in claim 7,
wherein at least a second selection of the second channels runs at least in sections into channels of the stator winding head.

10. The cooling apparatus as claimed in claim 7,
wherein the second baffle cooling plate can be fitted to a second end section of the stator device laminated core.

11. The cooling apparatus as claimed in claim 7,
wherein the second pressure reservoir contains a coolant which flows from the second pressure reservoir to the second end section of the second channels if a lower static pressure prevails at the second end sections of the second channels than in the second pressure reservoir.

12. The cooling apparatus as claimed in claim 7, further comprising:
a second outlet, said second outlet being designed such that, in the cooling mode, the static pressure at the second end sections of the second channels is lower than in the second pressure reservoir.

13. The cooling apparatus as claimed in claim 8,
wherein first channels and second channels within the stator alternate in a circumferential direction.

14. An electrical machine comprising
a rotor and a stator having at least one stator winding having at least one stator laminated core and at least one stator winding head;
wherein the electrical machine comprises a cooling apparatus as claimed in claim 1.

15. The electrical machine as claimed in claim 14,
wherein the electrical machine is a generator and/or a motor.

16. The cooling apparatus as claimed in claim 13,
wherein first channels and second channels within the stator between stator laminated cores alternate in a circumferential direction.
